(19) United States
(12) Patent Application Publication
(10) Pub. No.: US 2017/0150743 A1
(43) Pub. Date: Jun. 1, 2017

(54) METHOD FOR MANUFACTURING EDIBLE OIL BEVERAGES USING POLYSACCHARIDE AND POLYSACCHARIDE POLYMERS

(71) Applicant: Hangzhou Xinwei Low-carbon Technology R&D Co., Ltd., Hangzhou (CN)

(72) Inventors: Zongxin YANG, Hangzhou (CN); Min ZHOU, Hangzhou (CN); Chunhui CHEN, Hangzhou (CN); Wenming LI, Hangzhou (CN); Kanwen QIU, Hangzhou (CN); Riqing FAN, Hangzhou (CN); Feng WEN, Hangzhou (CN)

(73) Assignee: Hangzhou Xinwei Low-carbon Technology R&D Co., Ltd ., Hangzhou (CN)

(21) Appl. No.: 15/335,431

(22) Filed: Oct. 27, 2016

(30) Foreign Application Priority Data
Nov. 30, 2015 (CN) 2015 108 524 21.1

(51) Int. Cl. A23L 2/60; A23L 2/44; A23L 2/38; A23L 2/46; A23L 2/56; A23L 2/52

(52) U.S. Cl. CPC A23L 2/60; A23L 2/56; A23L 2/52; A23L 2/38; A23L 2/46; A23L 2/44; A23V 2002/00

(57) ABSTRACT

A method for manufacturing edible oil beverages using polysaccharide and polysaccharide polymers is provided. The method is characterized by comprising the following steps: 1) preparing a polysaccharide and polysaccharide polymer buffer solution, namely, dissolving polysaccharide and polysaccharide polymers into a buffer solution, sterilizing, mixing, and rapidly stirring, thereby obtaining the polysaccharide and polysaccharide polymer buffer solution; 2) emulsifying edible oil, namely, adding edible oil into an emulsifier, and rapidly and violently stirring for emulsification, thereby obtaining edible oil emulsion; 3) mixing the polysaccharide and polysaccharide polymer buffer solution with the edible oil emulsion, adding a dispersion liquid, and rapidly stirring, thereby obtaining suspended polysaccharide and polysaccharide polymer edible oil mother liquor; 4) diluting the suspended polysaccharide and polysaccharide polymer edible oil mother liquor, adding a formula, stirring, and sterilizing, thereby obtaining a suspended polysaccharide and polysaccharide polymer edible oil beverages.

### CROSS REFERENCE TO RELATED APPLICATIONS

The present application claims priority to Chinese Patent Application CN 2015 108 524 21.1 filed on Nov. 30, 2015.

### BACKGROUND OF THE INVENTION

1. Technical Field

The present disclosure relates to a method for manufacturing edible oil beverages using polysaccharide and polysaccharide polymers, and in particular relates to a method for manufacturing beverages of oils such as astaxanthin oil, DHA, EPA, olive oil, camellia oil, palmitoleic acid and microalgae oil with high additional values by using polysaccharide and polysaccharide polymers, and belongs to the field of food, healthcare products and biomedicines.

2. Description of Related Art

Polysaccharide is a carbohydrate chain formed by combined glycosidic bonds, generally refers to a polymeric saccharide macromolecule carbohydrate consisting of more than 10 pieces of monosaccharide, and is expressed in a general formula (C6H10O5)n. Polysaccharides consisting of the same monosaccharide are called homopolysaccharides, such as starch, cellulose and glycogen. Polysaccharides consisting of different types of monosaccharides are called heteropolysaccharides, for example, arabic gum consists of pentose, galactose and the like. Polysaccharide is not a pure chemical substance but a mixture of substances in different polymerization extents. Polysaccharide is generally insoluble in water, is not sweet, can form no crystal and is free of reducibility or multirotation.

In the food industry, natural polysaccharides with high water solubility can be adopted to achieve functions such as thickening, stabilization and gelling. The natural polysaccharides include xanthomonas polysaccharide, chitosan, galactomannan, macromolecule linear polysaccharide, polygalacturonic acid and the like which are all chain-like macromolecules with relatively high linearity degrees, and contain or do not contain branched chains which are very short and are uniformly or non-uniformly distributed on main chains. This type of polysaccharide can be formed by a plurality of types of glycosyl such as neutral glycosyl, alkali glycosyl or acid glycosyl, and the glycosyl has or does not have charge groups, is unlikely to crystallize, and exists in an amorphous state as a whole. As the molecule expansion degree is relatively high, a great number of hydrophilic groups can be freed and exposed, and thus hydrophilicity of molecules can be high. Such type of polysaccharide can be called a polysaccharide gum.

The edible oils with high additional values generally refer to oils rich in unsaturated fatty acids which are essential for human bodies, including astaxanthin oil (extracted from haematococcus pluvialis), DHA, EPA, olive oil, palmitoleic acid, fish oil (including deep sea fish oil), camellia oil, rapeseed oil, low erucic acid rapeseed oil, myristoleic acid, high oleic acid rapeseed oil, safflower oil, almond oil, peanut oil and the like.

The edible oils with high additional values are very beneficial to human bodies and are an essential type of fat which needs to be acquired from food by human bodies. In daily life, people mainly acquire unsaturated fatty acids from food every day, and the main defect is that most unsaturated fatty acids can be damaged after being oxidized at high temperature, so that the human body's daily intake dosage is not adequate, particularly for children in the growth and development period. The present disclosure provides a method for manufacturing edible oil beverages using polysaccharide and polysaccharide polymers. The unsaturated fatty acids in the edible oil beverages can be effectively protected with a long expiration date and high human body absorption and utilization efficiency, and the edible oil beverages produced by using the method can be daily beverages offering a healthcare function and can be widely accepted by people, convenient to take and good in taste.

### BRIEF SUMMARY OF THE INVENTION

The present disclosure aims to provide a method for manufacturing edible oil beverages using polysaccharide and polysaccharide polymers. The edible oil beverages produced by using the method can be beverage products widely accepted by people, convenient to take and good in taste, and unsaturated fatty acid of the beverage products is not easily oxidized and is long in expiration date and high in human body absorption and utilization efficiency.

To achieve the purpose, according to the technical scheme of the present disclosure, a method for manufacturing edible oil beverages using polysaccharide and polysaccharide polymers is provided which includes the following steps:

1) preparing a polysaccharide and polysaccharide polymer buffer solution, namely, dissolving polysaccharide and polysaccharide polymers into a buffer solution, sterilizing, mixing, and rapidly stirring, thereby obtaining the polysaccharide and polysaccharide polymer buffer solution;

2) emulsifying edible oil, namely, adding edible oil into an emulsifier, and rapidly and violently stirring for emulsification, thereby obtaining an edible oil emulsion;

3) mixing the polysaccharide and polysaccharide polymer buffer solution with the edible oil emulsion, adding a dispersion liquid, and rapidly stirring, thereby obtaining suspended polysaccharide and polysaccharide polymer edible oil mother liquor;

4) diluting the suspended polysaccharide and polysaccharide polymer edible oil mother liquor, adding a formula, stirring, and sterilizing, thereby obtaining a suspended polysaccharide and polysaccharide polymer edible oil beverages.

The polysaccharide and the polysaccharide polymers in step 1) include but are not limited to: one, two or a combination of more of xanthomonas polysaccharide, chitosan, galactomannan, macromolecule linear polysaccharide and polygalacturonic acid; the polysaccharide and polysaccharide polymer buffer solution in step 1) includes but is not limited to: monopotassium phosphate and dipotassium phosphate and dipotassium phosphate and citric acid, and the pH value of the polysaccharide and polysaccharide polymer buffer solution is 2-7.5.

The ratio of the polysaccharide and the polysaccharide polymers to the buffer solution in step 1) is (0.1-4):(1-9).

The edible oil in step 2) includes but is not limited to: one, two or a combination of more of astaxanthin oil, DHA, EPA, olive oil, camellia oil, palmitoleic acid and microalgae oil; the emulsifier in step 2) includes but is not limited to: one, two or a combination of more of glycerin fatty acid ester, soybean lecithin, sucrose ester, anhydrous sorbitan ester, propylene glycol ester, monoglyceride, Span and Tween.

The ratio of the edible oil to the emulsifier and the water in step 2) is (0.1-3):(0.2-4):(1-8).

The dispersion liquid in step 3) includes but is not limited to xanthomonas polysaccharide, chitosan, galactomannan, macromolecule linear polysaccharide and polygalacturonic acid.

The mixing ratio of the polysaccharide and polysaccharide polymer buffer solution to the edible oil emulsion in step 3) is (2-8):(1-6).

The stirring speed and the stirring time in step 2) are 1000-20000 rpm and 2-30 minutes; the stirring speed and the stirring time in step 3) are 500-20000 rpm and 2-20 minutes; the stirring speed and the stirring time in step 4) are 500-10000 rpm and 1-15 minutes.

The formula in step 4) refers to food additives added into the edible oil beverages, and the food additives include a sweetening agent, a flavoring agent and a preservative; a sterilization method in step 4) includes but is not limited to: pasteurization, high temperature sterilization, high pressure sterilization and microwave sterilization.

The content of the polysaccharide and the polysaccharide polymers in step 4) is 0.1-10%.

The present disclosure has the beneficial effects of the active component of the product produced by using the method can be well protected and is not easy to oxidize, long in expiration date and high in human body absorption and utilization efficiency when being compared with those of products of the prior art.

### BRIEF DESCRIPTION OF THE SEVERAL VIEWS OF THE DRAWINGS

FIG. 1 shows the process flow diagram of the present disclosure.

### DETAILED DESCRIPTION OF THE INVENTION

Embodiments of the present disclosure are further described as follows. The embodiments are only to specifically describe the present disclosure and shall not be taken as a limitation to the present disclosure.

### Embodiment 1

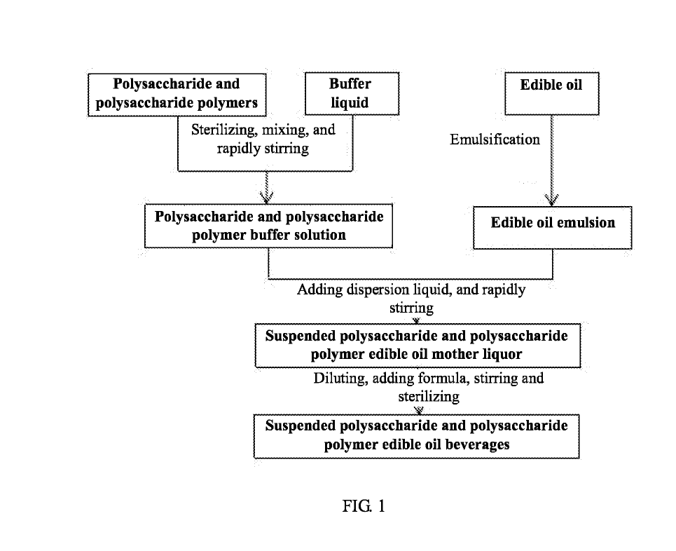

### See FIG. 1

A method for manufacturing an edible oil beverages using polysaccharide and polysaccharide polymers, characterized by including the following steps:

1) preparing a polysaccharide and polysaccharide polymer buffer solution, namely, dissolving polysaccharide and polysaccharide polymers (xanthomonas polysaccharide, chitosan and galactomannan) into a buffer solution (monopotassium phosphate and dipotassium phosphate, the pH value is 2) in a ratio of 0.1:1, sterilizing (high temperature sterilization), mixing, and rapidly stirring, thereby obtaining the polysaccharide and polysaccharide polymer buffer solution;

2) emulsifying edible oil, namely, adding edible oil (astaxanthin oil, olive oil and camellia oil) into an emulsifier (glycerin fatty acid ester and soybean lecithin), and rapidly and violently stirring for 2 minutes at a speed of 1000-20000 rpm for emulsification, thereby obtaining edible oil emulsion, wherein the ratio of the edible oil to the emulsifier and the water is 0.1:0.2:1;

3) mixing the polysaccharide and polysaccharide polymer buffer solution with the edible oil emulsion in a ratio of 2:1, adding a dispersion liquid (xanthomonas polysaccharide and chitosan), and rapidly stirring for 2 minutes at a speed of 500-20000 rpm, thereby obtaining suspended polysaccharide and polysaccharide polymer edible oil mother liquor;

4) diluting the suspended polysaccharide and polysaccharide polymer edible oil mother liquor, adding food additives (a sweetening agent, a flavoring agent and a preservative), stirring for 1 minute at a speed of 500 rpm, and implementing high pressure sterilization, thereby obtaining a suspended polysaccharide and polysaccharide polymer edible oil beverages, wherein the content of the polysaccharide and the polysaccharide polymers is 0.2%.

### Embodiment 2

A method for manufacturing an edible oil beverages using polysaccharide and polysaccharide polymers, characterized by including the following steps:

1) preparing a polysaccharide and polysaccharide polymer buffer solution, namely, dissolving polysaccharide and polysaccharide polymers (galactomannan, macromolecule linear polysaccharide and polygalacturonic acid) into a buffer solution (dipotassium phosphate and citric acid, the pH value is 5) in a ratio of 2:5, sterilizing, mixing, and rapidly stirring, thereby obtaining the polysaccharide and polysaccharide polymer buffer solution;

2) emulsifying edible oil, namely, adding edible oil (olive oil, camellia oil, palmitoleic acid and microalgae oil) into an emulsifier (sucrose ester, anhydrous sorbitan ester and propylene glycol ester), and rapidly and violently stirring for 15 minutes at a speed of 1000 rpm for emulsification, thereby obtaining an edible oil emulsion, wherein the ratio of the edible oil to the emulsifier and the water is 1.5:2:4;

3) mixing the polysaccharide and polysaccharide polymer buffer solution with the edible oil emulsion in a ratio of 5:3, adding a dispersion liquid (galactomannan, macromolecule linear polysaccharide and polygalacturonic acid), and rapidly stirring for 10 minutes at a speed of 10000 rpm, thereby obtaining suspended polysaccharide and polysaccharide polymer edible oil mother liquor;

4) diluting the suspended polysaccharide and polysaccharide polymer edible oil mother liquor, adding food additives (a sweetening agent, a flavoring agent and a preservative), stirring for 7 minutes at a speed of 5000 rpm, and implementing microwave sterilization, thereby obtaining a suspended polysaccharide and polysaccharide polymer edible oil beverages, wherein the content of the polysaccharide and the polysaccharide polymers in step 4) is 5%.

### Embodiment 3

A method for manufacturing an edible oil beverages using polysaccharide and polysaccharide polymers, characterized by including the following steps:

1) preparing a polysaccharide and polysaccharide polymer buffer solution, namely, dissolving polysaccharide and polysaccharide polymers (xanthomonas polysaccharide) into a buffer solution (dipotassium phosphate and citric acid, the pH value is 7.5) in a ratio of 4:9, sterilizing, mixing, and rapidly stirring, thereby obtaining the polysaccharide and polysaccharide polymer buffer solution;

2) emulsifying edible oil, namely, adding edible oil (astaxanthin oil and microalgae oil) into an emulsifier (soybean lecithin and sucrose ester), and rapidly and violently stirring for 30 minutes at a speed of 20000 rpm for emulsification, thereby obtaining edible oil emulsion, wherein the ratio of the edible oil to the emulsifier and the water is 3:4:8;

3) mixing the polysaccharide and polysaccharide polymer buffer solution with the edible oil emulsion in a ratio of 8:6, adding a dispersion liquid (galactomannan and macromolecule linear polysaccharide), and rapidly stirring for 20 minutes at a speed of 20000 rpm, thereby obtaining suspended polysaccharide and polysaccharide polymer edible oil mother liquor;

4) diluting the suspended polysaccharide and polysaccharide polymer edible oil mother liquor, adding food additives (a sweetening agent, a flavoring agent and a preservative), stirring for 15 minutes at a speed of 10000 rpm, and implementing pasteurization, thereby obtaining a suspended polysaccharide and polysaccharide polymer edible oil beverages, wherein the content of the polysaccharide and the polysaccharide polymers is 0.1-10%.

What is claimed is:

1. A method for manufacturing edible oil beverages using polysaccharide and polysaccharide polymers, comprising the following steps:
1) preparing a polysaccharide and polysaccharide polymer buffer solution, namely, dissolving polysaccharide and polysaccharide polymers into a buffer solution, sterilizing, mixing, and rapidly stirring, thereby obtaining the polysaccharide and polysaccharide polymer buffer solution;
2) emulsifying edible oil, namely, adding edible oil into an emulsifier, and rapidly and violently stirring for emulsification, thereby obtaining an edible oil emulsion;
3) mixing the polysaccharide and polysaccharide polymer buffer solution with the edible oil emulsion, adding a dispersion liquid, and rapidly stirring, thereby obtaining suspended polysaccharide and polysaccharide polymer edible oil mother liquor;
4) diluting the suspended polysaccharide and polysaccharide polymer edible oil mother liquor, adding a formula, stirring, and sterilizing, thereby obtaining a suspended polysaccharide and polysaccharide polymer edible oil beverages.

2. The method for manufacturing the edible oil beverages using the polysaccharide and the polysaccharide polymers according to claim 1, wherein the polysaccharide and the polysaccharide polymers in step 1) comprise but are not limited to: one, two or a combination of more of xanthomonas polysaccharide, chitosan, galactomannan, macromolecule linear polysaccharide and polygalacturonic acid; the polysaccharide and polysaccharide polymer buffer solution in step 1) comprises but is not limited to:
monopotassium phosphate and dipotassium phosphate and dipotassium phosphate and citric acid, and a pH value of the polysaccharide and polysaccharide polymer buffer solution is 2-7.5.

3. The method for manufacturing the edible oil beverages using the polysaccharide and the polysaccharide polymers according to claim 1, wherein the ratio of the polysaccharide and the polysaccharide polymers to the buffer solution in step 1) is (0.1-4):(1-9).

4. The method for manufacturing the edible oil beverages using the polysaccharide and the polysaccharide polymers according to claim 1, wherein the edible oil in step 2) comprises but is limited to: one, two or a combination of more of astaxanthin oil, DHA, EPA, olive oil, camellia oil, palmitoleic acid and microalgae oil; the emulsifier in step 2) comprises but is not limited to: one, two or a combination of more of glycerin fatty acid ester, soybean lecithin, sucrose ester, anhydrous sorbitan ester, propylene glycol ester, monoglyceride, Span and Tween.

5. The method for manufacturing the edible oil beverages using the polysaccharide and the polysaccharide polymers according to claim 1, wherein a ratio of the edible oil to the emulsifier and water in step 2) is (0.1-3):(0.2-4):(1-8).

6. The method for manufacturing the edible oil beverages using the polysaccharide and the polysaccharide polymers according to claim 1, wherein the dispersion liquid in step 3) comprises but is not limited to xanthomonas polysaccharide, chitosan, galactomannan, macromolecule linear polysaccharide and polygalacturonic acid.

7. The method for manufacturing the edible oil beverages using the polysaccharide and the polysaccharide polymers according to claim 1, wherein the mixing ratio of the polysaccharide and polysaccharide polymer buffer solution to the edible oil emulsion in step 3) is (2-8):(1-6).

8. The method for manufacturing the edible oil beverages using the polysaccharide and the polysaccharide polymers according to claim 1, wherein the stirring speed and the stirring time in step 2) are 1000-20000 rpm and 2-30 minutes; the stirring speed and the stirring time in step 3) are 500-20000 rpm and 2-20 minutes; the stirring speed and the stirring time in step 4) are 500-10000 rpm and 1-15 minutes.

9. The method for manufacturing the edible oil beverages using the polysaccharide and the polysaccharide polymers according to claim 1, wherein the formula in step 4) refers to food additives added into the edible oil beverages, and the food additives comprise a sweetening agent, a flavoring agent and a preservative; a sterilization method in step 4) comprises but is not limited to: pasteurization, high temperature sterilization, high pressure sterilization and microwave sterilization.

10. The method for manufacturing the edible oil beverages using the polysaccharide and the polysaccharide polymers according to claim 1, wherein the content of the polysaccharide and the polysaccharide polymers in step 4) is 0.1-10%.

11. The method for manufacturing the edible oil beverages using the polysaccharide and the polysaccharide polymers according to claim 2, wherein the ratio of the polysaccharide and the polysaccharide polymers to the buffer solution in step 1) is (0.1-4):(1-9).

12. The method for manufacturing the edible oil beverages using the polysaccharide and the polysaccharide polymers according to claim 4, wherein a ratio of the edible oil to the emulsifier and water in step 2) is (0.1-3):(0.2-4):(1-8).
